(19) United States
(12) Patent Application Publication
(10) Pub. No.: US 2006/0056440 A1
(43) Pub. Date: Mar. 16, 2006

(54) Managing conference communication in a communication system

(75) Inventor: Hisham Khartabil, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/987,116

(22) Filed: Nov. 15, 2004

(30) Foreign Application Priority Data
Sep. 16, 2004 (FI) 20041205

(51) Int. Cl. H04L 12/26; H04L 12/16; H04L 12/413

(52) U.S. Cl. 370/447; 370/230; 370/260

(57) ABSTRACT

A method manages communication over a shared resource in a communication system. A plurality of access requests are received, wherein at least one of the plurality of access requests is provided with a predefined indication whether the access request relates to a topic currently communicated over the shared resource or not. The plurality of access requests are verified for the predefined indication and are handled based on a predefined policy, wherein the predefined policy utilizes the predefined indication as one criterion. A managing entity and a communication system are configured to execute the method. A communication device is configured to create an access request provided with the predefined indication.

### FIELD OF THE INVENTION

The invention relates to communication systems, and more particularly to conference communication over a shared resource. In particular, the invention relates to managing conference communication over a shared resource in a communication system.

### BACKGROUND OF THE INVENTION

A communication system can be seen as a facility that enables communication sessions between two or more entities such as a communication device and/or other nodes associated with the communication system. Subscribers, such as the users or end-users, to a communication system may be offered and provided numerous services, such as calls, data communication or multimedia services or simply an access to a network, such as the Internet. The services may be offered by servers of an operator of the communication system or of an external service provider.

Examples of communication systems may include, but are not limited to, fixed line communication systems, such as a public switched telephone network (PSTN), wireless communication systems, such as a public land mobile network (PLMN), e.g. global system for mobile communications (GSM), general packet radio service (GPRS) and universal mobile telecommunications system (UMTS), other wireless systems, such as a wireless local area network (WLAN), and/or other communication networks, such as an Internet Protocol (IP) network and/or other packet switched data networks. Various communication systems may simultaneously be concerned in a connection.

Services offered to subscribers of a communication system may comprise conferencing services, such as multiparty conferencing, for example so-called direct voice communication services. One example of the direct voice communication services may comprise the “push-to-talk over cellular” (PoC) service also known as the PTT (push-to-talk service). The direct voice communication services may use capabilities of, for example, the Internet Protocol Multimedia Subsystem (IMS). The IMS enables IP connections for a communication device and other parties to the communication, such as other communication devices or entities associated with the network. The direct voice communication service may allow users to engage in immediate communication with one or more users.

The PoC service is an example of half-duplex communications, which means that one user may speak at the time and the others listen. A user may select a person or groups of persons they wish to talk to from a communication device the user is using and press and hold a push-to-talk key on the communication device to start talking. The user can now talk for as long as the user holds the key. The push-to talk key may be a specific button, tangent or any other appropriate key in a user interface. Similar principals apply with devices having touch sensitive or sound activated user interfaces. Bi-directional communication may be offered since all parties of the communication session may similarly communicate voice data with the PoC application server. As soon as the user releases the push-to-talk key, another member of the group may reserve a turn to speak. A turn to speak may be requested by pressing the push-to-talk key and granted on a first come first served basis or based on priorities. Talk bursts in the PoC conferences are usually connected without the recipient answering and typically received through a built-in loud speaker of a communication device.

Patent application US 2002/0150091, filed on 17 Apr. 2001, in the name of Lopponen et al. discusses about a packet mode, e.g. IP, group communication service layer provided on top of a standard mainstream cellular network.

U.S. patent application, filed on 7 Sep. 2004 by the Assignee, claiming priority of GB 0410270.3 (7 May 2004), and a GB application 0413972.1 (22 Jun. 2004), in the name of the assignee, discuss push-to-talk over cellular systems.

Conferencing applications often have shared resources such as the right to talk, input access to a limited-bandwidth video channel, or a pointer or input focus in a shared application. In many cases, it may be desirable to be able to control who can provide input, for example send, write or control, depending on the application, to the shared resource. It may also be desirable to control and set the pace for the topics discussed in a conference. For example, a user who wants to change a topic may be denied an access to the shared resource until the topic is perceived as concluded. A user may be granted the shared resource if the user wants to contribute to the currently discussed topic.

Floor control is a mechanism in a conferencing environment, in particular in a multiparty conferencing environment, for managing joint or exclusive access to a shared resource. For example, floor control may manage which user or users are allowed to speak to which listeners. Floor control may enable applications or users to gain safe and mutually exclusive or non-exclusive input access to the shared object or resource, such as the floor for media control, e.g. voice.

Requirements for a floor control protocol for multiparty conferences in the context of an existing framework are defined in Koskelainen et al., Requirements for Floor Control Protocol, draft-ietf-xcon-floor-control-req-01.txt, July 2004. This IETF (Internet Engineering Task Force, www.ietf.org) Internet-draft defines as a floor control protocol requirement for communication between a participant and a server that it should be possible for a participant requesting a floor to give additional information about the request, such as the topic of the question for an audio floor. Furthermore, the Internet-draft notes that, in some scenarios, the floor control server or the floor control chair, also known as floor moderator, may use this information when granting the floor to the user, or when making manipulation to the floor sets at the server.

Using a floor request topic is a way for the floor requester to indicate to the floor chair on what topic the floor requester wants to discuss. This requires the user to type in a topic before requesting the floor. This may take time and effort by the user and may result in the user being late in making a contribution to a topic that was being discussed. Also, this may not be possible, for example if an automaton, such as a machine or a piece of software, is chairing the floor. Automata are typically unable to understand and intelligently interpret text.

Therefore, there is a need for a more efficient and/or more automata friendly way to indicate on what topic a user requesting a floor wants to say something.

### SUMMARY OF THE INVENTION

Embodiments of the invention aim to address one or several of the above problems or issues.

In accordance with an aspect of the invention, there is provided a method for managing communication over a shared resource in a communication system. The method comprises receiving a plurality of access requests, wherein at least one of the plurality of access requests is provided with a predefined indication whether the access request relates to a topic currently communicated over the shared resource or not. The method further comprises verifying the plurality of access requests for the predefined indication. The method further comprises handling the plurality of access requests based on a predefined policy, wherein the predefined policy utilizes the predefined indication as one criterion.

In accordance with another aspect of the invention, there is provided a method for requesting an access for communication over a shared resource in a communication system. The method comprises creating an access request provided with a predefined indication whether the access request relates to a topic currently communicated over the shared resource or not. The method further comprises sending the access request to a managing entity managing the access for communication.

In accordance with another aspect of the invention, there is provided a managing entity for managing communication over a shared resource in a communication system. The managing entity is configured to receive a plurality of access requests, wherein at least one of the plurality of access requests is provided with a predefined indication whether the access request relates to a topic currently communicated over the shared resource or not. The managing entity is further configured to verify the plurality of access requests for the predefined indication. The managing entity is further configured to handle the plurality of access requests based on a predefined policy, wherein the predefined policy utilizes the predefined indication as one criterion.

In accordance with another aspect of the invention, there is provided a communication system comprising such a managing entity.

In accordance with another aspect of the invention, there is provided a communication device configured to participate in communication over a shared resource in a communication system. The communication device is configured to create an access request provided with a predefined indication whether the access request relates to a topic currently communicated over a shared resource in a communication system or not. The communication device is further configured to send the access request to a managing entity managing conference communication over the shared resource.

In accordance with another aspect of the invention, there is provided a user interface for a communication device. The user interface comprises control means for allowing a user to indicate a selection and detecting means for detecting the selection of the user. The user interface further comprises communicating means for communicating the selection of the user to a creating means of the communication device for creating an access request provided with a predefined indication whether the access request relates to a topic currently communicated over a shared resource in a communication system or not, wherein the predefined indication gets a value from the selection of the user.

In an embodiment, at least one access request may be provided with a topic flag, configured to get one of a first predefined value indicating that the access request relates to the topic currently communicated over the shared resource and a second predefined value indicating that the access request relates to a different topic than the topic currently communicated over the shared resource. A floor control protocol may be used in creating and transmitting access requests, which are further provided with the predefined indication.

In an embodiment the plurality of access requests may be verified for the predefined indication. From the access requests comprising the predefined indication, a value of the predefined indication may be verified.

In an embodiment, an access may be granted when the predefined indication of an access request indicates that the access request relates to the topic currently communicated over the shared resource. In an embodiment, an access request may be rejected when the predefined indication indicates that the access request relates to a different topic than the topic currently communicated over the shared resource.

In an embodiment, an access request may be accepted and held in a queue when there is ongoing communication over the shared resource. The access request may be held in a first queue when the predefined indication indicates that the access request relates to the topic currently communicated over the shared resource. The access request may be held in a second queue when the predefined indication indicates that the access request relates to a different topic than the topic currently communicated over the shared resource. In an embodiment, when there is no predefined indication in the access request, the access request may be held in one of the first and the second queue. In an embodiment, when there is no predefined indication in the access request, the access request may be held in a third queue.

In an embodiment, at least two access requests with the predefined indication set to a same value indicating that the topic shall not change may be received. In such an embodiment, a second criterion may be utilized in the predefined policy.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented; and

FIG. 2 shows a signaling chart illustrating an embodiment of the invention.

### DETAILED DESCRIPTION OF PREFERRED EMBODIMENTS

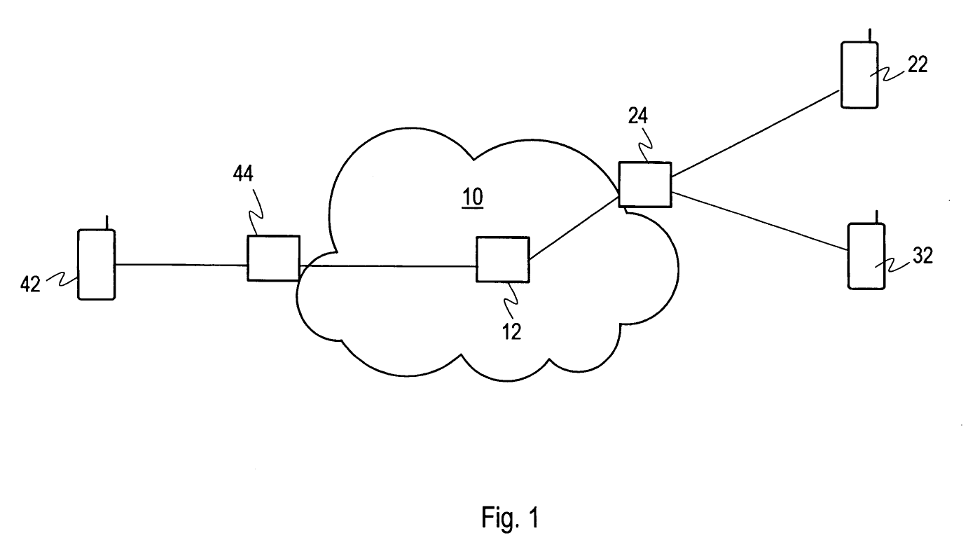

FIG. 1 shows an example of an arrangement including a communication network 10, a first communication device 22, a second communication device 32 and a third communication device 42. The first communication device 22 is shown to access the communication network 10 via an access entity 24. The first communication device may, for example, wirelessly transmit and receive radio signals via a radio interface to and from a transceiver network element connected to the access entity 24. Correspondingly, the transceiver network element may wirelessly transmit and receive radio signals to and from the communication device 22. Furthermore, the second communication device 32 is shown to access the communication network 10 via the access entity 24. The third communication device 42 is shown to access the communication network 10 via an access entity 44.

A floor control server 12 managing access to shared resource and relating to a floor chair is also shown. Operation of the exemplifying floor control server shall become clear from the following examples of embodiments of the invention.

It shall be appreciated that FIG. 1 is only an example showing only three communication devices. Typically, a plurality of communication devices is simultaneously communicating via a communication network. Furthermore, a communication device may have several simultaneous communication sessions, for example a number of SIP sessions and activated packet data protocol (PDP) contexts. The communication devices may be connected to the communication system from the same or different networks. The communication devices may access the communication network 10 via any appropriate access system. Examples may include, but are not limited to, radio access networks, e.g. an UMTS terrestrial radio access network (UTRAN) or a GSM/EDGE radio access network (GERAN), and short-range wireless systems, such as the Bluetooth, and so on. The communication network 10 may comprise any appropriate communication network or networks. In an embodiment, the communication network 10 may be provided at least in part by the IMS.

Names of the entities in a communication system depend on the system. For example, access entities of radio access networks may comprise a controller, such as a radio network controller (RNC) in 3GPP (Third Generation Partnership Project) systems and base station controller (BSC) in 3GPP2 (Third Generation Partnership Project 2) systems. Furthermore, even if omitted from FIG. 1, a communication system typically comprises various further switching and other control entities and gateways for enabling the communication via a number of radio access networks and also for interfacing a single communication system with one or more other communication systems. Several transceiver network elements, in other words transmitter/receivers, such as Node B in 3GPP, BTS (base transceiver station) in 3GPP2, may be included in a single radio access network.

An end-user may access a communication network by means of any appropriate communication device, such as user equipment (UE), a mobile station (MS), a cellular phone, a personal digital assistant (PDA) or the like, or other devices, such as a personal computer (PC), or any other equipment operable according to a suitable network protocol, such as a Session Initiation Protocol (SIP), a wireless applications protocol (WAP) or a hypertext transfer protocol (HTTP). A communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. The user interface may display a user a menu, a list or the like and allow the user to select an option from the menu. The user may indicate the selection by using the control means. The user interface may detect user activity and communicate the selection to a communicating logic of the communication device. A communication device is typically provided with a processor and memory means as well as software and applications operating the device and enabling operation with other entities. Software, which is able to request services from other entities in a communication system, may be called a client.

A communication system, for example the IMS, may support the session initiation protocol (SIP) as developed by the Internet engineering task force (IETF), see e.g. IETF RFC 3261 “SIP: Session Initiation Protocol”. The SIP is an application layer control protocol for creating, modifying and terminating sessions with one or more participants, i.e. end-points. A user connected to a SIP base communication system may communicate with various entities of the communication system based on standardized SIP messages. Communication devices or users who run certain applications on the communication devices are registered with the SIP backbone so that an invitation to a particular session can be correctly delivered to these end points. The SIP provides a registration mechanism for devices and users and applies mechanisms such as location servers and registrars to route the session invitations appropriately.

Uniform Resource Identifiers (URIs) are used to identify different types of actors in a SIP-controlled network. Typically a URI points to a registered user identity of an individual user. A URI may identify also services, such as voicemail server or conference factory URI, conferencing instances, such as chat rooms or voice-over-IP (VoIP) conferencing instances, or other types of resources.

Embodiments of the invention may be implemented, for example, in multiparty conferencing services, such as PoC services. A PoC system may be integrated within a cellular telecommunication system and may be implemented using push-to-talk servers in the IMS. The PoC service is based on multi-unicasting. Each transmitting communication device may send packet data traffic to a dedicated push-to-talk server. In case of a group call, the server may duplicate or multiply the traffic to be received by all recipients. Principles of the invention may be implemented also in other multiparty conferencing services.

A conference, such as the PoC, can be created in various ways. For example, the SIP or the Conference Policy Protocol (CPCP) may be used. The CPCP is discussed, for example, in Khartabil et al by IETF, The Conference Policy Control Protocol (CPCP), draft-ietf-xcon-cpcp-00 September 2004. Voice and data control traffic may be carried through a real time protocol (RTP) streaming bearer. The RTP is defined in IETF RFC 3550 “RTP: A Transport Protocol for Real-Time Applications”. The RTP provides end-to-end delivery services for data with real-time characteristics, such as interactive audio and video, and supports data transfer to multiple destinations using multicast distribution if provided by the underlying network. Floor control may be used together with the CPCP. Or, floor control may be used independently of how the conference was created.

The floor may be defined as a permission to temporarily access or manipulate a specific shared resource or set of resources. A user or an entity who manages one floor, for example grants, denies or revokes a floor, is a floor chair or a floor moderator. Entities managing the floor may comprise automata. Floor control server is a logical entity that maintains the state of the floor(s) including which floors exists, who the floor chairs are, who holds a floor, and so on. Requests to manipulate a floor are directed at the floor control server and further to a floor moderator. A user requesting a floor is termed as a floor requester set. A logical data structure identifying all participants who currently hold the floor is a floor holder set.

A floor control server may co-locate with a conference server, a conference bridge, a conference focus or can be stand alone. A conference focus is a SIP user agent that is addressed by a conference URI and identifies a conference. The focus maintains a SIP signaling relationship with each participant in the conference and implements conference policies. The focus is a logical role responsible for ensuring, in some way, that each participant receives the media that make up the conference.

The floor control server 12 shown in FIG. 1 may be an application server or a part of an application server generally connected to the IMS or to another appropriate communication system. The floor control server 12 may be related to a floor chair or to a floor moderator and provide floor control for multiparty conferencing services.

A floor chair or moderator, as defined in Koskelainen et al., Requirements for Floor Control Protocol, draft-ietf-xcon-floor-control-req-01.txt, July 2004, is a user (or an entity) who manages one floor (grants, denies or revokes a floor). The floor chair does not have to be a member in a conference. A server, but also one of the participants or a third party, may act as a floor chair. As defined in paragraph 4 of Koskelainen, a floor control protocol is used to convey the floor control messages among the floor chairs (moderator) of the conference, the floor control server, and the participants of the conference. All messages go via one point, the floor control server. Processing (granting or rejecting) floor control requests is done by the one or more floor chairs or by the server itself, depending on the policy. According to Koskelainen, paragraph 7.1, a participant requesting a floor may be able to give additional information about the request, such as the topic of the question for an audio floor.

A floor control protocol is binary and carries different pieces of information. In Camarillo et al. The Binary Floor Control Protocol (BFCP), http://www.softarmor.com/xcon/drafts/draft-ietf-xcon-bfcp-00.txt, July 2004, paragraph 6.1, a floor request format is currently defined as follows:
FloorRequest=(FIXED-HEADER)
   (TRANSACTION-ID)
   (USER-ID)
   8 BENEFICIARY-ID]
   [PRIVACY]
   [FLOOR-REQUEST-ID]
   *(FLOOR-ID)
   [HUMAN-READABLE-INFO]
   [PRIORITY]
   [INTEGRITY]

According to Camarillo, clients request a floor by sending a FloorRequest message to the floor control server. In addition, the FloorRequest message is also used to modify existing floor requests. The FLOOR-ID field identifies uniquely a floor within a conference. The HUMAN-READABLE-INFO field may be used to give the additional information about the request, such as the topic of the question for the audio floor as defined in Koskelainen and mentioned above.

It has now been found that, instead of using a topic typed as text in a floor protocol field, a new field or flag may be introduced in a request for floor, such as the FloorRequest of the floor control protocol indicating if the floor requester wants to contribute to the current topic or wants to change topics. In this specification, the new field is generally refrred to as a “topic flag” and may be named as a “new-topic” flag and a “topic-change” flag or, in an alternative, a “current-topic” or “keep-topic” flag. Values that the fields may get depend on the definition of the field. In the following, some examples are given to illustrate this. However, it shall be appreciated that any another sequence of characters or the like may as well be used as the field name and the values the field gets may vary a lot from what is described. In particular, a “current-topic” or “keep-topic” field might get values that indicate contrary to similar values when the field is named as “new-topic” or “topic-change”.

The topic flag may be provided by means of a fixed length field or a field getting predefined selectable values in the floor control protocol. In an embodiment, the topic flag may be a one-bit field having possible values of 0 (zero) and 1 (one), as will be described in the following. In an alternative, another predefined, simple indication, such as a sequence of numbers or characters may be used. An example of an alternative predefined sequence may comprise true/false sequence. Preferably, the predefined indication is readily interpreted by an automaton, such as a machine or software. Furthermore, preferably, the predefined indication enables an automatic creation, by an application or software in the communication device, of additional information about the topic of the question to be provided to the floor control server.

In an embodiment, the topic flag may be named a “new-topic” or “change-topic” flag or the like. The floor requester may set the “new-topic” flag to a value 0 indicating that the floor requester wants to say something related to the currently discussed topic. The floor requester may alternatively set the “new-topic” flag to 1 to indicate a change in topic. In an alternative, a value “false” may be used to denote that the floor requester wants to say something related to the currently discussed topic and a value “true” to indicate that the floor requester wants to start a new topic.

In an alternative, the new field may be named a “current-topic” or “keep-topic” flag or the like. The floor requester may set the current-topic flag to a value 1 indicating that the floor requester wants to say something related to the currently discussed topic. The floor requester may alternatively set the new topic flag to 0 to indicate a change in topic. In an alternative, a value “true” may be used to denote that the floor requester wants to say something related to the currently discussed topic and a value “false” to indicate that the floor requester wants to start a new topic.

In a further embodiment, the new field may be named simply a “topic” flag or the like. The floor requester may set the topic flag to a value “current” indicating that the floor requester wants to say something related to the currently discussed topic. The floor requester may alternatively set the topic flag to “new” to indicate a change in topic.

The user requesting the floor does not have to type in any text. This topic flag can be used by humans as well as automata. The topic flag may be used to give priority to floor requests. In an embodiment, floor requests or access requests may be hold in a queue when an access is granted immediately. The topic flag may be used to separate the queue of floor requests into two queues, one for current topic and one for new topics, even entirely automatically. The floor request may be accepted and then placed in an appropriate queue. This may result in two floor request status reports being sent to the requester, one indicating that request is accepted and the other indicating that the request is queued.

In an embodiment, the topic flag may have a default value, either current or new topic, which will be set if no interaction or preference from the user is detected when the user is requesting the floor.

In an embodiment, the topic flag may be optional. In the optional topic flag embodiment, the topic flag is included in the floor request if the user sets the topic flag and, if no preference from the user is detected, the floor request procedure may be done without an indication of a topic. When the topic flag is missing from the floor or access request, the floor moderator may interpret as unknown whether the requester wanted to change the topic or not. In an embodiment, it may also be set that no topic flag has a default meaning, such as no change in topic, and only a requester wishing to change the topic sets the topic flag.

In an embodiment, the topic flag may have an indication of unknown value, when no action relating to setting the predefined indication is detected in the communication device.

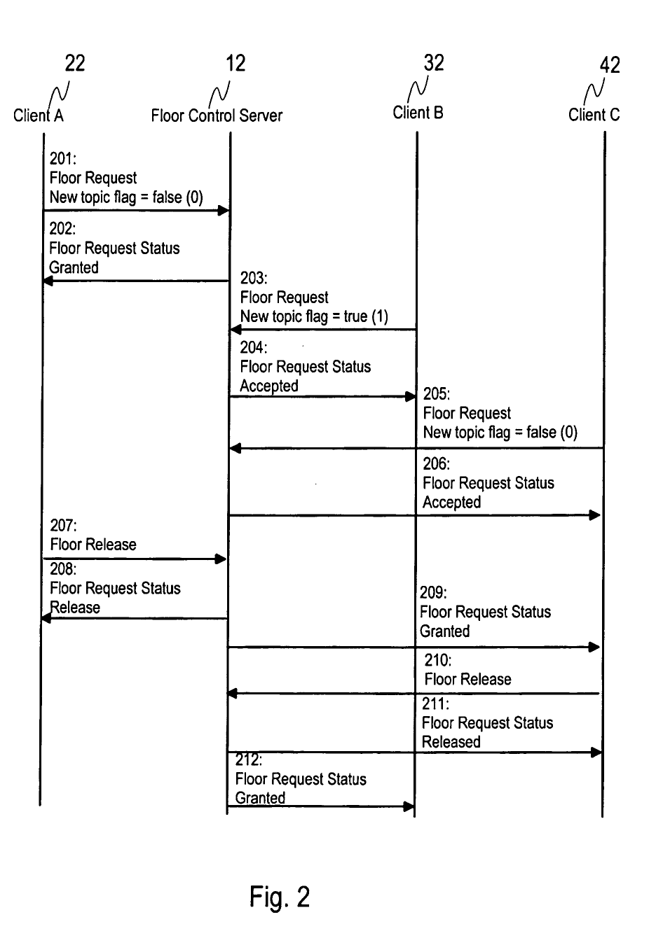

FIG. 2 shows a signaling chart illustrating an embodiment of the invention.

In signal 201, client A 22 requests the floor by sending a floor request to a floor control server 12. Client A 22 claims that the topic will not change by setting a “new-topic” flag in the floor request to false, e.g. value 0. In signal 202, the floor control server 12 grants the floor.

In signal 203, client B 32 immediately after requests the floor stating that he wishes to change topics by setting the “new-topic” flag to true, e.g. value 1. Client B 32 is put in the queue and informed that the request is accepted in signal 204.

In signal 205, client C 42 then requests the floor also claiming no change in topic will happen. The floor control server 12 places the floor request of client C 42 request ahead of client B 32 in the queue. Client C 42 is notified accordingly in signal 206.

In signal 207, client A 22 releases the floor. The floor control server 12 sends an updated status signal 208 to client A 22. In signal 209, the floor control server 12 grants the floor to client C 42 ahead of client B 32, since the topic will not change. When client C 42 releases the floor in signal 210 and the floor control server answers in signal 211, the floor control server determines that there are no more requests for the floor for the current topic. In signal 212, the floor control server 12 grants the floor to client B 32.

The floor control server 12 may relate to a floor chair or a floor moderator, which can be a human or automata, such as a machine or software. The requests 201 203 and 205 of FIG. 2 may be forwarded by the floor control server 12 to the floor chair or moderator that accepts, rejects or grants the floor request. For clarity, those flows called chair actions between the floor control server 12 and the floor chair or moderator are not shown in FIG. 2.

Furthermore, when client A 22 is, for example, granted the floor, Clients B 32 and C 42 may receive floor status information. These flows are also omitted from FIG. 2 for clarity.

In an embodiment, multiple users may simultaneously request access to a floor, all indicating topic change in the same manner, for example all setting the new-topic flag to false indicating that the topic shall not change. In such a case, the floor chair may apply a second criterion for granting floor. For example, the floor chair may grant the floor first to a user whose request was first received and subsequently the further users in an order the requests were received. Such principle may be referred to as, for example, first-come-first-served type of grant or a first-in-first-out queue.

The above embodiment is one exemplifying way of how a floor control server and thereby a floor chair can handle the topic flag information. Another way of handling the topic flag information may be to reject floor requests when the topic flag indicates that the floor requester intends to change the topic.

A user interface of a device may offer to a user a user-friendly way to decide to which position the topic flag should be set. During an active conference session, the user interface may allow the user easily to indicate whether the user wants to contribute to current topic or change the topic. The user interface of the device may, for example, have a specific key for this purpose. The user can indicate a preference by pressing the key at the same time or right before the user starts to press the push-to-talk key. Pressing the key will cause setting the topic flag to either one of the values, new topic or current topic. Correspondingly, not pressing the key while requesting the floor may cause setting the flag to the alternative value or requesting the floor without including the topic flag in the request.

Although the invention has been described in the context of particular embodiments, various modifications are possible without departing from the scope and spirit of the invention as defined by the appended claims. It should be appreciated that whilst embodiments of the present invention have mainly been described in relation to mobile communication devices, such as mobile user equipment, embodiments of the present invention may be applicable to other types of communication devices that may access communication networks and participate in group communication over a shared resource. Furthermore, the communication system may be any appropriate communication system providing group communication over a shared resource, even if reference has mainly been made to mobile communication systems.

1. A method for managing communication over a shared resource in a communication system, the method comprising:
receiving a plurality of access requests, wherein at least one access request of the plurality of access requests is provided with a predefined indication whether the at least one access request relates to a topic currently communicated over a shared resource;
verifying the plurality of access requests for the predefined indication; and
handling the plurality of access requests based on a predefined policy, wherein the predefined policy utilizes the predefined indication as a criterion.

2. A method according to claim 1, wherein the step of receiving the plurality of access requests comprises receiving the at least one access request provided with a topic flag, configured to get one of a first predefined value indicating that the at least one access request relates to the topic currently communicated over the shared resource and a second predefined value indicating that the at least one access request relates to a different topic than the topic currently communicated over the shared resource.

3. A method according to claim 1, wherein the step of receiving the plurality of access requests comprises receiving the at least one access request in accordance with a floor control protocol provided with the predefined indication.

4. A method according to claim 1, wherein the step of verifying comprises verifying whether the plurality of access requests comprises the predefined indication and, from the plurality of access requests comprising the predefined indication, verifying a value of the predefined indication.

5. A method according to claim 1, wherein the step of handling comprises at least one of granting an access, accepting and holding an access request and rejecting an access request.

6. A method according to claim 5, wherein the step of handling comprises granting the access when the predefined indication of the access request indicates that the access request relates to the topic currently communicated over the shared resource.

7. A method according to claim 5, wherein the step of handling comprises rejecting the access request when the predefined indication indicates that the access request relates to a different topic than the topic currently communicated over the shared resource.

8. A method according to claim 5, wherein the step of handling comprises accepting the access request and holding the access request in at least one queue when there is ongoing communication over the shared resource.

9. A method according to claim 8, wherein the step of holding comprises holding the access request in a first queue when the predefined indication indicates that the access request relates to the topic currently communicated over the shared resource.

10. A method according to claim 9, wherein the step of holding comprises holding the access request in a second queue when the predefined indication indicates that the access request relates to a different topic than the topic currently communicated over the shared resource.

11. A method according to claim 10, wherein the step of holding comprises holding the access request in one of the first and the second queue when the access request is received without said predefined indication.

12. A method according to claim 10, wherein the step of holding comprises holding the access request in a third queue when the access request is received without said predefined indication.

13. A method according to claim 1, wherein the step of receiving comprises receiving at least two access requests, each having the predefined indication set to a same value, and the step of handling comprises utilizing another criterion in the predefined policy.

14. A method according to claim 1, wherein the step of receiving comprises receiving an access request with no predefined indication and wherein the step of handling comprises interpreting the access request as being unknown whether the access request relates to a change of the topic and having a default meaning.

15. A computer program embodied on a computer-readable medium, said program configured to control a computer to perform the steps of:
receiving a plurality of access requests, wherein at least one access request of the plurality of access requests is provided with a predetermined indication whether the at least one access request relates to a topic currently communicated over a shared resource;
verifying the plurality of access requests for the predefined indication; and
handling the plurality of access requests based on a predefined policy, wherein the predefined policy utilizes the predefined indication as a criterion.

16. A method for requesting an access for communication over a shared resource in a communication system, the method comprising:
creating an access request provided with a predefined indication whether the access request relates to a topic currently communicated over a shared resource; and
sending the access request to a managing entity managing an access for communication.

17. A method according to claim 16, wherein the step of creating comprises creating the access request provided with a topic flag, the topic flag configured to get one of a first predefined value indicating that the access request relates to the topic currently communicated over the shared resource and a second predefined value indicating that the access request relates to a different topic than the topic currently communicated over the shared resource.

18. A method according to claim 16, wherein the step of creating comprises setting the predefined indication using one of a key, a tangent, a button, a touch sensitive area and a sound activation means in a communication device dedicated for providing the access request with the predefined indication.

19. A method according to claim 16, wherein the step of creating comprises providing a default value for the predefined indication when no action related to setting the predefined indication is detected.

20. A method according to claim 16, wherein the step of creating comprises providing the predefined indication with one of no value and an indication of unknown value when no action related to setting the predefined indication is detected.

21. A method according to claim 16, wherein the step of sending the access request comprises sending the access request in accordance with a floor control protocol, that is provided with the predefined indication.

22. A computer program embodied on a computer-readable medium, said program configured to control a computer to perform the steps of:
creating an access request provided with a predetermined indication whether the access request relates to a topic currently communicated over a shared resource; and
sending the access request to a managing entity managing an access for communication.

23. A managing entity for managing communication over a shared resource in a communication system, the managing entity configured to:
receive a plurality of access requests, wherein at least one access request of the plurality of access requests is provided with a predefined indication whether the at least one access request relates to a topic currently communicated over a shared resource;
verify the plurality of access requests for the predefined indication; and
handle the plurality of access requests based on a predefined policy, wherein the predefined policy utilizes the predefined indication as a criterion.

24. A managing entity according to claim 23, wherein the predefined indication comprises a topic flag, the topic flag configured to get one of a first predefined value indicating that said access request relates to the topic currently communicated over the shared resource and a second predefined value indicating that said access request relates to a different topic than the topic currently communicated over the shared resource.

25. A managing entity according to claim 23, configured to receive the at least one access request in accordance with a floor control protocol, that is provided with the predefined indication.

26. A managing entity according to claim 23, configured to verify whether the plurality of access requests comprises the predefined indication and, from the plurality of access requests comprising the predefined indication, to verify a value of the predefined indication.

27. A managing entity according to claim 23, configured to grant an access, accept and hold an access request or reject said access request.

28. A managing entity according to claim 27, configured to grant said access when the predefined indication of said access request indicates that the access request relates to the topic currently communicated over the shared resource.

29. A managing entity according to claim 27, configured to reject said access request when the predefined indication indicates that the access request relates to a different topic than the topic currently communicated over the shared resource.

30. A managing entity according to claim 27, configured to accept said access request and hold the access request in at least one queue when there is ongoing communication over the shared resource.

31. A managing entity according to claim 30, configured to hold the access request in a first queue when the predefined indication indicates that the access request relates to the topic currently communicated over the shared resource.

32. A managing entity according to claim 31, configured to hold the access request in a second queue when the predefined indication indicates that the access request relates to a different topic than the topic currently communicated over the shared resource.

33. A managing entity according to claim 32, configured to hold the access request in one of the first and the second queue when the access request is received without said predefined indication.

34. A managing entity according to claim 32, configured to hold the access request in a third queue when the access request is received without said predefined indication.

35. A managing entity according to claim 23, configured to receive at least two access requests, each having the predefined indication set to a same value, and to utilize another criterion in the predefined policy.

36. A managing entity according to claim 23, configured to receive an access request with no predefined indication and to interpret the access request as being unknown whether the access request relates to a change of topic and having a default meaning.

37. A managing entity according to claim 23, comprising one of a multiparty conferencing server, a push-to-talk over cellular server, a participant of the communication over the shared resource and a third party.

38. A managing entity managing conference communication over a shared resource in a communication system, the managing entity comprising:
receiving means for receiving a plurality of access requests, wherein at least one access request of the plurality of access requests is provided with a predefined indication whether the at least one access request relates to a topic currently communicated over a shared resource;
verifying means for verifying the plurality of access requests for the predefined indication; and
handling means for handling the plurality of access requests based on a predefined policy, wherein the predefined policy utilizes the predefined indication as a criterion.

39. A communication system comprising:
a managing entity to manage communication over a shared resource, wherein said managing entity is configured to
receive a plurality of access requests, wherein at least one access request of the plurality of access requests is provided with a predefined indication whether the at least one access request relates to a topic currently communicated over a shared resource,
verify the plurality of access requests for the predefined indication, and
handle the plurality of access requests based on a predefined policy, wherein the predefined policy utilizes the predefined indication as a criterion.

40. A communication device configured to participate in communication over a shared resource in a communication system, the communication device configured to:
create an access request provided with a predefined indication whether the access request relates to a topic currently communicated over a shared resource in a communication system; and
send the access request to a managing entity that manages conference communication over the shared resource.

41. A communication device according to claim 40, wherein the access request is provided with a topic flag, the topic flag configured to get one of a first predefined value indicating that the access request relates to the topic currently communicated over the shared resource and a second predefined value indicating that the access request relates to a different topic than the topic currently communicated over the shared resource.

42. A communication device according to claim 40, wherein the predefined indication is provided with a default value when no action related to setting the predefined indication is detected in a user interface.

43. A communication device according to claim 40, wherein the predefined indication is provided with one of no value and an indication of unknown value when no action related to setting the predefined indication is detected in the communication device.

44. A communication device according to claim 40, configured to create the access request in accordance with a floor control protocol that is provided with the predefined indication.

45. A communication device configured to participate in communication over a shared resource in a communication system, the communication device comprising:
creating means for creating an access request provided with a predefined indication whether the access request relates to a topic currently communicated over a shared resource in a communication system; and
sending means for sending the access request to a server that manages conference communication over the shared resource.

46. A communication device according to claim 45, wherein the creating means comprises one of a key, a tangent, a button, a touch sensitive area and a sound activation means dedicated for providing the access request with the predefined indication.

47. A communication device configured to participate in communication over a shared resource in a communication system, the communication device configured to:
create an access request provided with a predefined indication whether the access request relates to a topic currently communicated over a shared resource in a communication system; and
send the access request to a managing entity that manages conference communication over the shared resource.

48. A communication device according to claim 47, wherein the communication over said shared resource comprises one of multiparty conferencing and push-to-talk over cellular communication.

49. A user interface for a communication device, the user interface comprising:
control means for allowing a user to indicate a selection;
detecting means for detecting the selection of the user; and
communicating means for communicating the selection of the user to a creating means of the communication device for creating an access request provided with a predefined indication whether the access request relates to a topic currently communicated over a shared resource in a communication system, wherein the predefined indication gets a value from the selection of the user.

50. A communication system comprising:
a managing entity to manage communication over a shared resource, wherein said managing entity includes
receiving means for receiving a plurality of access requests, wherein at least one access request of the plurality of access requests is provided with a predefined indication whether the at least one access request relates to a topic currently communicated over the shared resource,
verifying means for verifying the plurality of access requests for the predefined indication, and
handling means for handling the plurality of access requests based on a predefined policy utilizes the predefined indication as a criterion.
